(19) United States
(12) Patent Application Publication
(10) Pub. No.: US 2020/0065897 A1
(43) Pub. Date: Feb. 27, 2020

(54) FINANCIAL INSTRUMENT PRICING

(71) Applicant: Zetatango Technology Inc., Mississauga (CA)

(72) Inventors: Brian McBride, Dunrobin (CA); Peter Rabinovitch, Ottawa (CA)

(21) Appl. No.: 16/111,441

(22) Filed: Aug. 24, 2018

(51) Int. Cl. G06Q 40/02

(52) U.S. Cl. CPC G06Q 40/025

(57) ABSTRACT

A method of calculating a price for a financial instrument comprises receiving a plurality of external data and receiving a financial instrument configuration. In response to the financial instrument configuration adapting the plurality of external data to produce a plurality of corresponding derived data. The adapting comprises adjusted the plurality of external data by a weighting. In response to the plurality of derived data determining a credit worthiness probability distribution function based on the plurality of derived data. In response to configuration rules determining a relationship between a price of the financial instrument and credit worthiness. Receiving a target probability and utilizing the credit worthiness probability distribution function to determine a confidence interval of credit worthiness. Utilizing the relationship between a price of the financial instrument and credit worthiness and the confidence interval of credit worthiness to determine a confidence interval of price and determining a price.

### FIELD OF THE INVENTION

The present invention relates to the evaluation of risk and pricing of capital services and more particularly to the use of probability distributions to produce a price estimate for financial instruments commensurate with risk.

### BACKGROUND

It is a real and common challenge for many financial and commercial institutions to evaluate risk and determine a price when extending capital services or selling financial instruments to another organization or customer. Currently, lending can only be done by specialized companies because of the significant cost and expertise required to evaluate risk and meet regulations. This prohibits the growth of the credit industry into instruments that can be cost effectively used in products where the company is not a specialized lender. Capital services may include a merchant cash advance, working capital, line of credit, invoice financing, etc. Loans or credit may be extended by banks, stores, schools, unions, and any number of organizations.

When considering capital services, lenders will typically take into account their own risk profile, amount of capital, the types of businesses they are lending to and other factors. Banks and similar financial institutions specialize in this but the methods they use are often based on human factors that are subjective, biased and imprecise. Often, they rely on personal experience and biases. Smaller organizations or less experienced organizations are at a loss to evaluate risk and determine prices for capital services and must rely on banks or unsupportable estimates.

There exist multiple sources of data to evaluate risk and pricing for a transaction, but it is often unclear and difficult to obtain the data and use it to obtain an actionable price that takes into account the customer's ability to pay and the amount of risk the lender is willing to incur. It is impossible for people to consider 600 factors to make a risk decision since they think in a serialized manner. Manual methods rely on simplistic recipes to follow that are static and approximate over large populations. For many organizations that may want to extend credit the problem is too difficult to solve in an accurate and timely manner.

There exists a need for an accurate method of estimating the credit worthiness of a customer and determining a price for a loan that is usable by a large number of organizations, regardless of their experience in capital services.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a risk assessment platform 100 in accordance with one embodiment.

FIG. 2 illustrates a data flow 200 in accordance with one embodiment.

FIG. 3 illustrates a no knowledge credit worthiness 300 in accordance with one embodiment.

FIG. 4 illustrates a high credit score credit worthiness 400 in accordance with one embodiment.

FIG. 5 illustrates a credit worthiness with hard constraints 500 in accordance with one embodiment.

FIG. 6 illustrates a credit worthiness with high credit score and low industry default rates 600 in accordance with one embodiment.

FIG. 7 illustrates a relationship between price and credit worthiness 700 in accordance with one embodiment.

FIG. 8 illustrates a confidence interval and credit worthiness 800 in accordance with one embodiment.

FIG. 9 illustrates a confidence interval of price 900 in accordance with one embodiment.

FIG. 10 illustrates a processing platform 1000 in accordance with one embodiment.

FIG. 11 illustrates a risk modelling and pricing 1100 in accordance with one embodiment.

### DETAILED DESCRIPTION

The present invention is direct to providing a method of providing lenders of capital services with pricing estimates for financial instruments based on their acceptable exposure to risk and the credit worthiness of the customer. In some embodiments the customer may be a borrower or may be a merchant who is the user of the financial instrument. This specification uses the term application to refer to a pair comprising an instrument and a customer.

Embodiments of the invention comprise machine learning and artificial intelligence (AI) computer systems that may be provided as a lending-as-a-service (LaaS) or software-as-a-service (SaaS) service to users. It may also be implemented as a variety of standalone, client-server, and cloud computing configurations.

Risk of default of an individual customer is difficult to define precisely. Risk must be assessed with respect to the parameters of each particular scenario. Examples of parameters include principal, time, term, etc. For example, an individual is very likely to repay $1000 in one year and so has very low risk for that scenario. On the other hand, it may be very difficult for the same individual to repay $1,000,000 in one year, and so that would be a very risky scenario. Embodiments of the invention express risk as a probability distribution rather than a point, discrete, or single number estimate. For example, is much more useful to say the probability of a merchant repaying an advance is uniform between 0.6 and 0.9 with 95% probability than to say their probability of repaying is 0.75 (the mean). This is not a fault of using the mean, but rather of expecting any single figure of merit to accurately capture anything beyond the most simplistic scenarios.

Embodiments will operate in an environment where the number input signals that are available will vary. More will become available over time, and others will cease to be available. Some will not be allowed to be used in specific contexts (jurisdictions, etc.) due to legal, cultural, or business reasons, but allowed in others. Some signals will be available, but not in a timely manner, and so will only be available for use at a later time. The signals will have varying quality (accuracy, timeliness, resolution, etc.). Some of the signals will have a large impact on credit worthiness, chance of default, or price, and some will have little effect. The effect of each signal may also vary over time. Signals may also be combined in different ways in order to create new derived signals.

Some signals may be represented as hard constraints, whereby a particular signal must have a specific value in order to offer an instrument. Examples of this include not lending to a merchant that has gone bankrupt in the past two years or not lending to an individual under the age of majority. In these cases, no matter what the customer's credit worthiness based on other factors, the financial instrument or loan would not be approved at any price.

As there will be many data signals and the data signals will vary in format, accuracy, units, etc., embodiments will treat data signals in a consistent manner. The treatment remains the same for each group of instruments and for each type of customer.

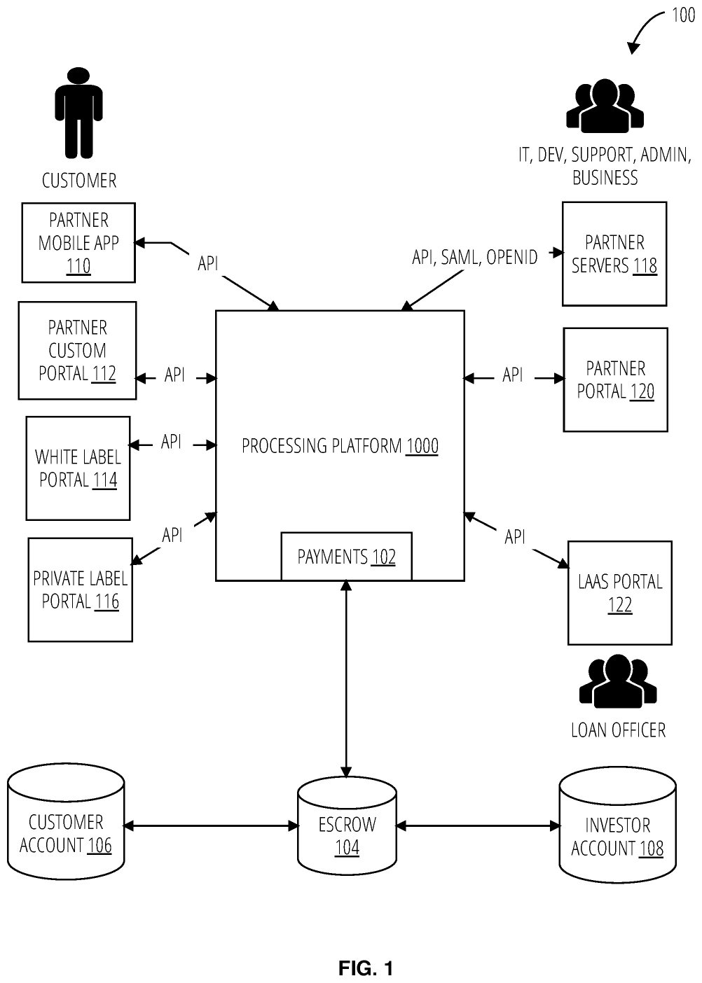

Embodiments of the invention as illustrated in FIG. 1 are centered on a processing platform 1000 that accepts data from a number of sources through APIs. Customer data will be received through any number of portals such as a partner mobile app 110, partner custom portal 112, white label portal 114, or private label portal 116 through REST APIs. Bulk data may also be imported into the system. The various portals provide LaaS to customers through the respective portals and apps. Lenders, which includes loan officers and equivalent, may access the processing platform 1000 through REST APIs that are used by a LaaS portal 122 or similar. Other stakeholders, which includes IT, developers, support, admin, and business people also interface with the processing platform 1000 through REST APIs that are used by partner servers 118, partner portal 120, and other similar interfaces. Payments 102 are handled with the use of escrow 104 accounts which may link a customer account 106 with an investor account 108.

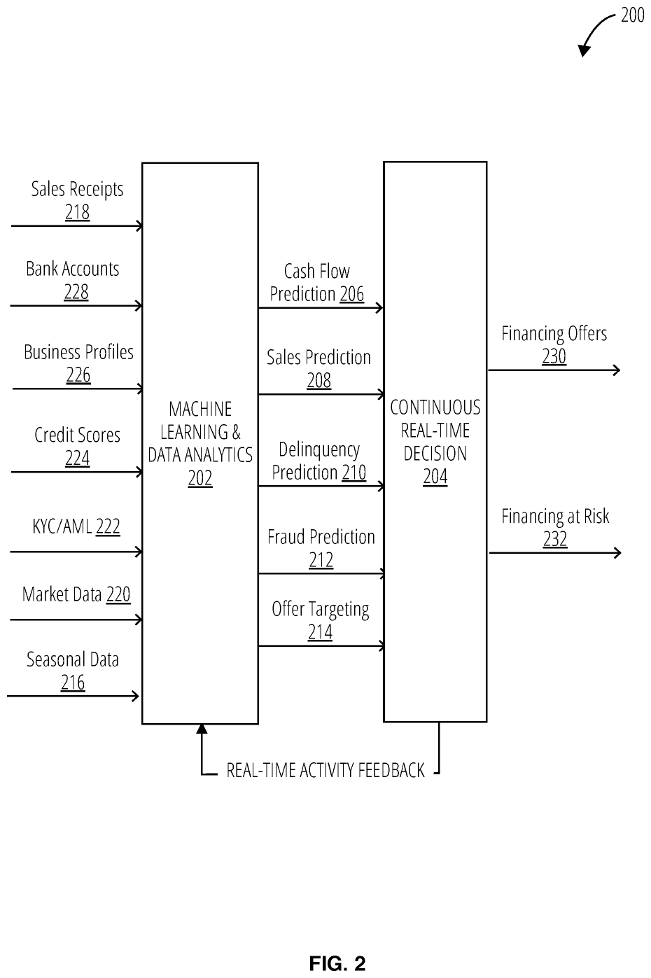

FIG. 2 gives an overview of the data flow 200 as used in embodiments of the invention. Processing platform 1000 comprises a machine learning & data analytics 202 module and a continuous real-time decision 204 module. The machine learning & data analytics 202 module is continuously analyzing the set of data signals to determine which signals are most useful, which signals most effect the results, how they need to be transformed, how to best adapt and weight the raw signals, etc. External signal inputs include sources such as sales receipts 218, bank accounts 228, business profiles 226, credit scores 224, KYC/AML 222 information, market data 220, seasonal data 216, and others. Multiple sources of the same type may also be used. For example, credit scores 224 from multiple sources may be used. Signals are processed by the machine learning & data analytics 202 module to produce several intermediate results such as cash flow prediction 206, sales prediction 208, delinquency prediction 210, fraud prediction 212, offer targeting 214, and others.

Cash flow prediction 206 and sales prediction 208 are fed back internally for use within the processing platform 1000. Delinquency prediction 210 is used in the estimating the distribution of credit worthiness 1012. A low delinquency prediction 210 is an indicator that the customer may have a hard time repaying the instrument which may be due to different reasons. Fraud prediction 212 comprises industry norms for predicting the probability of fraud as well as a more direct prediction of the probability of fraud for an application instrument/customer pair. Offer targeting 214 estimates an optimum return given a value of an instrument and optimal return for a given overall risk tolerance. Offer targeting 214 aggregates the risk/reward profiles of the customers to identify who may be interested in an instrument. As inputs change the machine learning & data analytics 202 module continuously updates the intermediate results which are used by the continuous real-time decision 204 module to produce financing offers 230 and financing at risk 232 outputs.

Embodiments of the invention utilize a probability distribution function (PDF) of a customer's credit worthiness as modelled by a beta distribution. Other embodiments may be modelled using a different function. Each PDF is a probability distribution for a particular customer. Credit worthiness is a number between 0 and 1, with higher numbers representing the customer being more credit worthy. The PDF may also be used to extract additional data such as the mean, percentile, a confidence interval (for example, a 95% confidence interval). The confidence interval determines a region where a customer's credit worthiness lies with the lower bound being a conservative estimate. A slider variable may also be used to select a point within the confidence interval. For example, consider a customer where their credit worthiness has been calculated to lie between 0.8 to 0.97 and so we have high confidence that they can pay back their loan. On the other hand, a less credit worthy customer may have a 95% confidence interval for their credit worthiness of 0 to 0.75, and so using the lower bound of the CI would yield a 0 for their credit worthiness.

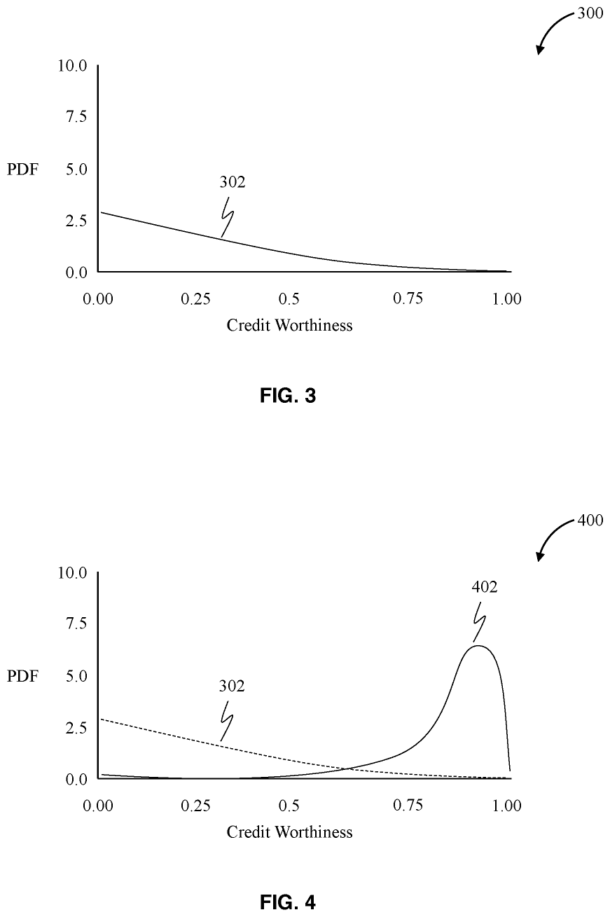

FIG. 3 illustrates a new customer applying for credit. Given no knowledge of their credit worthiness data for the general population may be used to generate a no knowledge risk profile 302 to be used as an initial starting point.

FIG. 4 illustrates how the addition of additional signal data affects the credit worthiness PDF. If credit score data is available, it can be used to modify or replace the no knowledge risk profile 302. High credit score risk profile 402 illustrates a PDF for a customer with a good credit record.

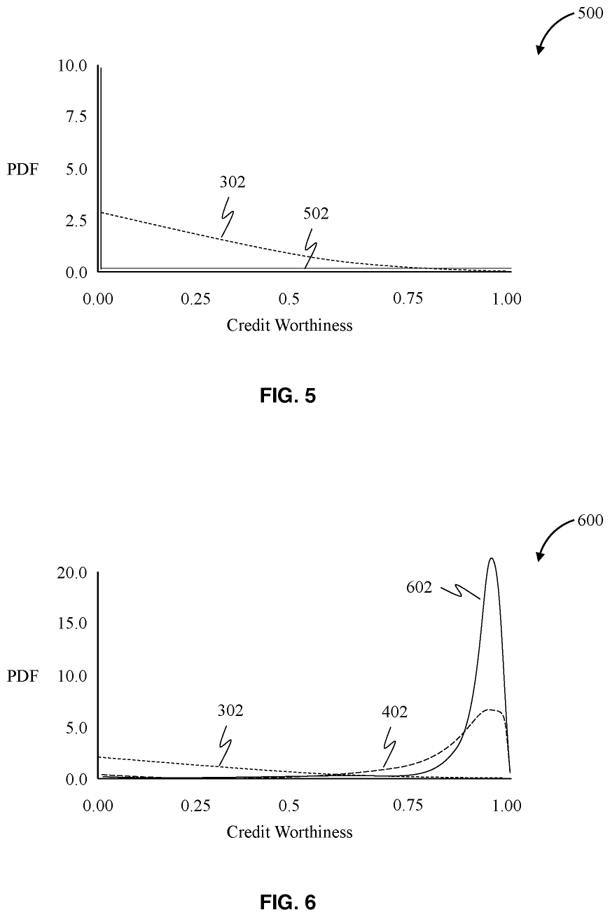

FIG. 5 illustrates a PDF of credit worthiness that represents a hard constraint or limiting risk profile 502 such as age requirements or a past bankruptcy that puts a limit on the PDF. In the case where some data leads to a customer having (for whatever reason) a high credit score (as in FIG. 4) but the customers had a bankruptcy 18 months ago. Then their credit worthiness profile becomes limiting risk profile 502 that indicates an impulse function at 0 followed by a 0 PDF up until a credit worthiness of 1.

FIG. 6 illustrates how data may be combined to obtain a more accurate PDF of credit worthiness. The combination of a customer with a high credit score from a credit agency with a good reputation or from multiple credit agencies produces a higher credit score than the high credit score risk profile 402. If this is combined with industry data indicating the at there are low default rates in the industry if produces the high credit score in industry with low default rates profile 602 as illustrated.

Once a credit worthiness PDF has been established embodiments of the invention convert this to a price function. A financial instrument will typically have a principal and a fee portion that may be used to derive a price. For example, an instrument with principal $10,000 and a fee of $1,250 would have a price of 1.125. A loan with an interest rate of 17% would have a price of 1.17. Credit worthiness is a number between 0 and 1, with higher numbers representing the customer being more credit worthy. Therefore, credit worthiness may be mapped to a price by a variety of functions that map [0,1] to [1, ∞]. In most embodiments the minimum price is constrained to 1, as anything less than one would imply a money loosing instrument. One function that does this mapping is

$$r = a + \frac{1 - x}{bx} ,$$

where a is the price for a customer with perfect credit worthiness, x is a customer's credit worthiness, and b is a parameter that can be used to adjust the shape of the credit worthiness vs price 702 curve. The first credit worthiness vs price 702 curve illustrates the relationship for one set of values of a and b. The second credit worthiness vs price 704 curve illustrates the relationship for a second set of values of a and b.

In order to specify the family of curves for different values of a and b in some embodiments it is desirable to have a formula for a midpoint curve. For example, say at 0.5 credit worthiness the price is y, and of course at credit worthiness 1 we want the price to be a. In this case the value for b is given by

$$b = \frac{1}{y - 1} .$$

In other embodiments, other curves may be used. In some embodiments the curve

$$r = a + \frac{1 - {x}^{c}}{bx}$$

may be used, where c controls the curvature of the line. Other embodiments may use other formulas.

FIG. 8 illustrates how a confidence interval and credit worthiness 800 may be used to determine a probability of credit worthiness. This allows the selection of prices based on a target confidence level that the loan will be paid back. In various embodiments, this may be 90%, 95%, or 99%. The target confidence level is chosen to determine a PDF level 802 which determines the vertical bounds CI of credit worthiness 806 that define the area 810 under the graph 808. The bounds CI of credit worthiness 806 determine the confidence interval for credit worthiness for the application.

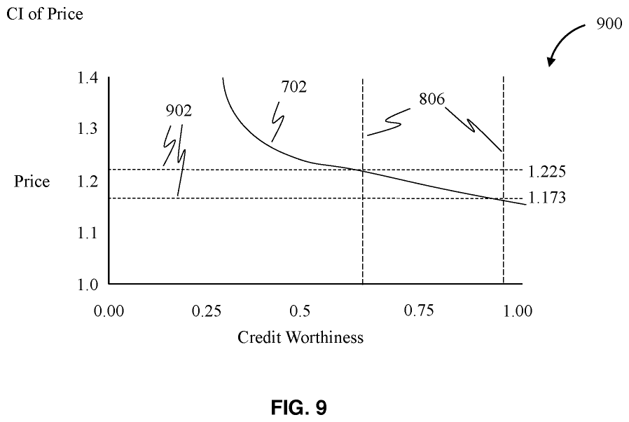

FIG. 9 illustrates how the confidence interval and credit worthiness 800 can be used to obtain a confidence interval of price 900. The CI of credit worthiness 806 is intersected with the credit worthiness vs price 702 curve to determine the CI for price 902. In the illustrative example shown a price between 1.173 and 1.225 is returned for the CI of credit worthiness 806 determined in FIG. 8. A slider 1016 can then be used to make a final adjustment to determine a single price 1018 or range of prices within the CI for price 902.

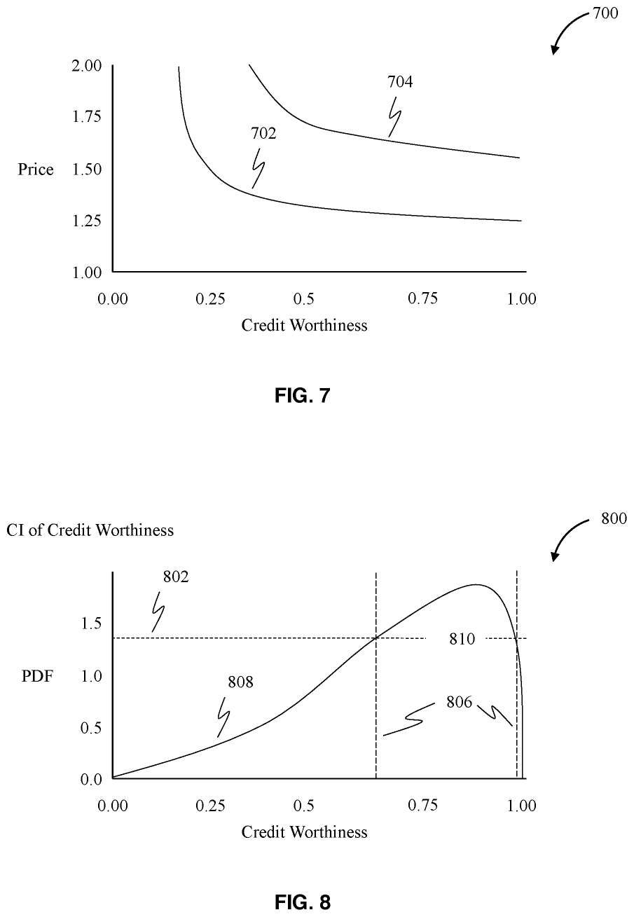

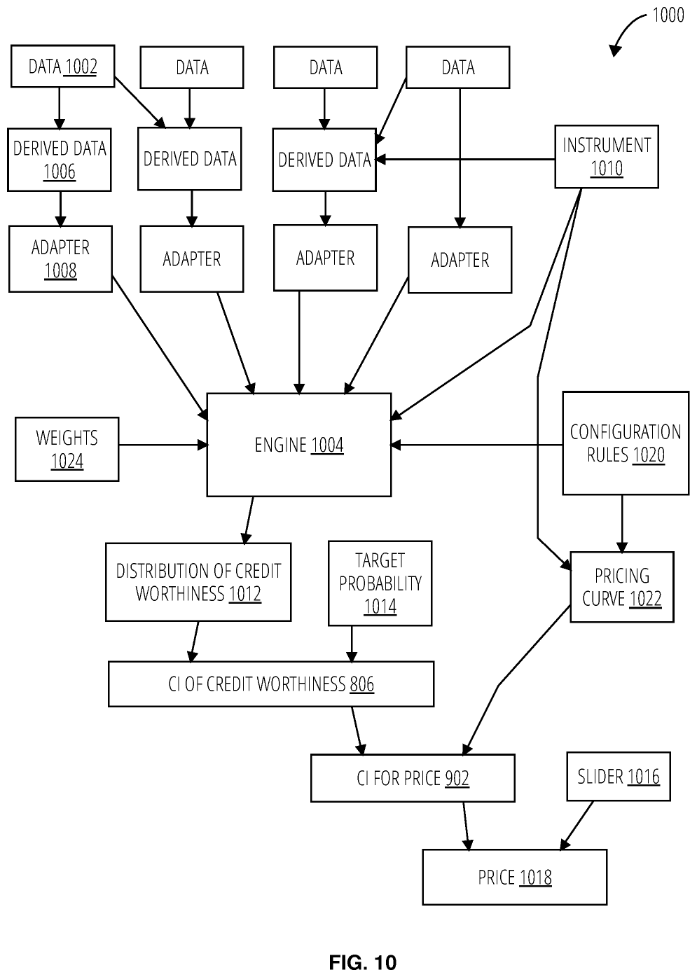

FIG. 10 illustrates a processing platform 1000 according to some embodiments. Data 1002 refers to raw signal data that is received by the processing platform 1000 through APIs. Data is then processed to obtain derived data 1006 or may be used as is. Derived data 1006 is obtained through statistical analysis, machine learning, or some other process applied to the raw data 1002. The derived data 1006 may be used to summarize data in a way that it results in an overall improvement in the performance of the system. One example would be to use a single mean of a slowly varying sequence of raw input data 1002 in place of the data sequence 1002 itself. Derived data 1006 may accept a single data 1002 input or multiple data 1002 inputs. Derived data 1006 or unaltered data 1002 are then transformed by an adapter 1008 which is responsible for formatting and transforming the data into a common format that is understandable by the engine 1004 of the processing platform 1000. The adapter 1008 output is in the form of a probability distribution. In some embodiments this probability distribution may be expressed as a beta distribution (see FIG. 7) that may be characterized by variables a and b. Adapter 1008 output may be further adjusted to modify the value of the data. One example would be to modify the adjusted data by the mean of the data. Another example would be to modify the adjusted data by the standard deviation of the data to reflect the amount of uncertainty in the data. Some data 1002 will be better indicators than other data and weights 1024 may be applied to the adapter 1008 outputs to give more weight to the better indicators. The derived data 1006, represented by probability distribution functions (PDFs) and weighted, are the final inputs to the engine 1004 which is configured by the configuration rules 1020. The instrument 1010, is also used to define parameters for the derived data, engine 1004, and pricing curve 1022. This can be used to define a simple credit check for a small loan and require more information for a larger loan. The engine 1004 outputs a distribution of credit worthiness 1012 PDF that provides an estimate of credit worthiness for an application (pair of instrument and customer) as a probability distribution. A target probability 1014 is input as an indicator of the amount of risk that is acceptable for the application. This yields a confidence interval (CI) referred to as a CI of credit worthiness 806. The CI of credit worthiness 806 combined with the pricing curve 1022 of the instrument 1010, yields a CI for price 902. This may be adjusted with a slider 1016 to yield a final price 1018.

In some embodiments, data of a certain type may not be used for a particular instrument 1010 or due to configuration rules 1020. This may be due to government regulations based on age or place of residence. Prohibited data 1002 may be discarded, given zero weights 1024, or be flagged to be ignored.

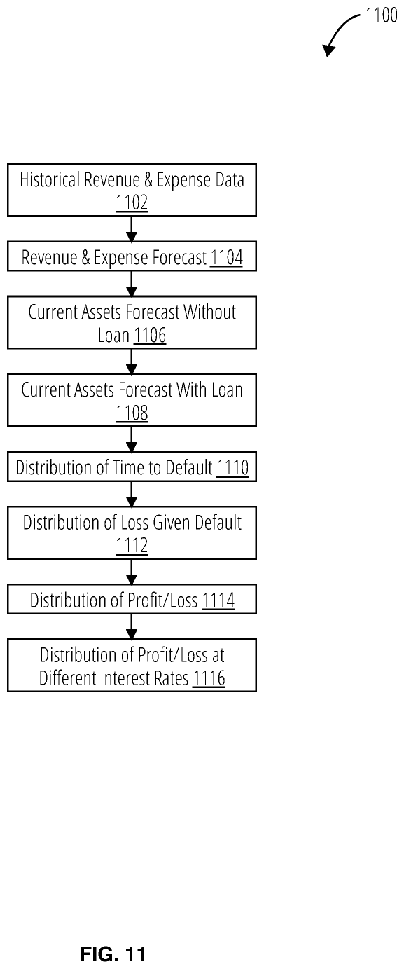

FIG. 11 illustrates how embodiments of the invention may be used to evaluate the risk and estimate a price for financial instruments such as unsecured business loans. Base data comprising historical revenue & expense data 1102 may be used as a starting point. By utilizing several year's data cyclical data on a weekly, biweekly, monthly, quarterly, seasonal basis may be identified. Historical data may also be used to gain a qualitative or quantitative understanding of the noise incorporated in the data. Revenue & expense forecast 1104 data is then simulated using a large number of possible outcomes. These forecasts will take into account credit scores, general business conditions, factors specific to the particular merchant, etc. Using an initial value of current assets of the business seeking the loan, an estimate of current assets forecast without loan 1106 may be made. This estimate may be made on a daily, weekly, monthly, or other periodic basis. The estimate may be made for a period of, for example, one year depending on a variety of factors including the term of the loan, amount of loan, etc. Next, current assets forecast with loan 1108 is forecast in a similar manner to current assets forecast without loan 1106. The effects of the loan include the positive affect on current assets due to the amount of the loan as well as the negative influence on current assets caused by the loan payments. A PDF indicating the distribution of time to default 1110 is utilized to determine the distribution of the time to default which may be expressed in days, weeks, months, etc. A second PDF is determined to model the magnitude and distribution of loss should a default 1112 occur. By utilizing the distribution of time to default 1110 and the distribution of loss given default 1112 and knowing the payment schedule and amounts if no default occurs a distribution of profit/loss 1114 if obtained. This distribution of profit/loss 1114 may be then determined for several distribution of profit/loss at different interest rates 1116. With this data a price, interest rate and other parameters of a loan may be determined for machine learning & data analytics 202 application 302. The output of 1116 becomes one of the inputs to 1006

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

What is claimed is:

1. A method of calculating a price for a financial instrument, the method comprising:
receiving a plurality of external data;
receiving a financial instrument configuration;
in response to the financial instrument configuration adapting the plurality of external data to produce a plurality of corresponding derived data, the adapting comprising adjusted the plurality of external data by a weighting;
in response to the plurality of derived data determining a credit worthiness probability distribution function based on the plurality of derived data;
in response to configuration rules determining a relationship between a price of the financial instrument and credit worthiness;
receiving a target probability and utilizing the credit worthiness probability distribution function to determine a confidence interval of credit worthiness;
utilizing the relationship between a price of the financial instrument and credit worthiness and the confidence interval of credit worthiness to determine a confidence interval of price; and
determining a price of the financial instrument within the confidence interval of price.

2. The method of claim 1 further comprising modifying the price to produce an adjusted price.

3. The method of claim 1 wherein the plurality of external data comprises a no knowledge risk profile for the financial instrument.

4. The method of claim 1 wherein the plurality of external data comprises a hard constraint to limit the maximum or minimum of the price.

5. A non-transitory computer-readable storage medium, the computer-readable storage medium including instructions that when executed by a computer, cause the computer to:
receive a plurality of external data;
receive a financial instrument configuration;
in response to the financial instrument configuration adapting the plurality of external data to produce a plurality of corresponding derived data, the adapting comprising adjusted the plurality of external data by a weighting;
in response to the plurality of derived data determine a credit worthiness probability distribution function based on the plurality of derived data;
in response to configuration rules determine a relationship between a price of the financial instrument and credit worthiness;
receive a target probability and utilizing the credit worthiness probability distribution function to determine a confidence interval of credit worthiness;
utilize the relationship between a price of the financial instrument and credit worthiness and the confidence interval of credit worthiness to determine a confidence interval of price; and
determine a price of the financial instrument within the confidence interval of price.

6. A computing apparatus including a processor and a memory storing instructions that, when executed by the processor, configure the apparatus to perform the method of claim.
